(19) United States
(12) Patent Application Publication
(10) Pub. No.: US 2019/0231103 A1
(43) Pub. Date: Aug. 1, 2019

(54) KEEPER FOR ORDERLY STORAGE AND CONVEYANCE OF CLOTHING HANGERS

(71) Applicant: Yolanda Sosa Mata, Brownsville, TX (US)

(72) Inventor: Yolanda Sosa Mata, Brownsville, TX (US)

(21) Appl. No.: 15/882,569

(22) Filed: Jan. 29, 2018

(51) Int. Cl. A47G 25/14; F16B 2/22; F16B 45/00

(52) U.S. Cl. CPC A47G 25/1464; F16B 45/00; F16B 2/22

(57) ABSTRACT

A keeper for orderly storage and/or conveyance of clothing hangers includes an elongate hanger collection and retention chute dependently supported within a chute support recess, which recess is provided in connection with a generally elongate rigid body. The chute comprises an open end to a central slot, running substantially the length of the chute, and whereby the chute receives the corner portion of a number of clothing hangers. The rigid body has a guide directing the corner portion of a hanger through an open throat of the body and into the open end of the collection and retention chute. Protuberances, provided in generally aligned pairs extending from the interior side walls of the chute, jut inward toward the central slot to demark, and serve as stops between, provided adjacent hanger support slots.

### FIELD OF THE INVENTION

The present invention relates to domestic activities. More particularly, the invention relates to a keeper specially adapted to readily collect clothing type hangers between uses, and thereafter maintain the collected hangers in an orderly fashion until needed again, at which time the keeper is also adapted to easily dispense the hangers.

### BACKGROUND OF THE INVENTION

Clothing type hangers are notoriously difficult to store and transport without the hangers becoming entangled one with another. Additionally, it is often very difficult to hold onto any number beyond a small few hangers without losing grip. Still further, these problems become most acute when one is travelling to a laundry facility or the like, as such a person is also generally burdened with carrying not only the hangers, but also the clothing to be laundered, laundry detergents and similar products, as well as personal belongings.

Notwithstanding the long felt need for better means to handle clothing type hangers, the foregoing problems remain unsolved. With the shortcomings of the prior art clearly in mind, it is therefore an overriding object of the present invention to provide a keeper that is specially adapted to readily collect clothing type hangers between uses, to maintain the collected hangers in an orderly fashion until needed again, and to provide for the ready access to individual hangers when needed.

It is a further object of the present invention to provide such a keeper that is easy to use, and therefore presents no burden in the solution of the foregoing deficiencies of the prior art.

It is a further object still of the present invention to provide such a keeper that is also economical to manufacture, and therefore readily available to all that may benefit therefrom.

### SUMMARY OF THE INVENTION

In accordance with the foregoing objects, the present invention—a keeper for orderly storage and/or conveyance of clothing hangers—generally comprises an elongate hanger collection and retention chute dependently supported within a chute support recess, which recess is provided in connection with a generally elongate rigid body. The chute comprises an open end to a central slot, running substantially the length of the chute, and whereby the chute is adapted to receive therein the corner portion of a number of clothing hangers. The rigid body most preferably implements a guide adapted to direct the corner portion of a hanger through an open throat of the body and into the open end of the collection and retention chute.

In order to receive and keep organized a plurality of clothing hangers, the preferred implementation of the collection and retention chute provides a plurality of clothing hanger support slots. Protuberances, which are provided in generally aligned pairs extending from the interior side walls of the chute, jut inward toward the central slot to demark, and serve as stops between, adjacent hanger support slots. In order to enable passage, as desired, of the corner region of a hanger, while also serving to demark the hanger slots, the chute is formed of a malleable material such that at least the protuberances are adapted to give way to a passing corner region of a hanger.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein:

FIG. 1 shows, in an isometric view, a preferred implementation according to the present invention of a keeper for orderly storage and/or conveyance of clothing hangers;

FIG. 2 shows, in a side elevation view, various details of the keeper of FIG. 1;

FIG. 3 shows, in another isometric view, still further details of the keeper of FIG. 1;

FIG. 4 shows, in a detail view located in FIG. 3, various details of the opening to a chute, as implemented in the keeper of FIG. 1;

FIG. 5 shows, in an isometric view, various details of the keeper of FIG. 1, as deployed in use, and, in particular, various details of the collection of a clothing hanger;

FIG. 6 shows, in an isometric view generally corresponding to that of FIG. 5, still further details of the collection of a hanger utilizing the keeper of FIG. 1;

FIG. 7 shows, in a detail view generally located in FIG. 2, various details of the operation of the provided chute; and

FIG. 8 shows, in an isometric view similar to that of FIGS. 5 and 6, various details of the keeper as deployed for dispensing a previously collected hanger.

### DETAILED DESCRIPTION OF THE PREFERRED EMBODIMENT

Although those of ordinary skill in the art will readily recognize many alternative embodiments, especially in light of the illustrations provided herein, this detailed description is exemplary of the preferred embodiment of the present invention, the scope of which is limited only by the claims appended hereto.

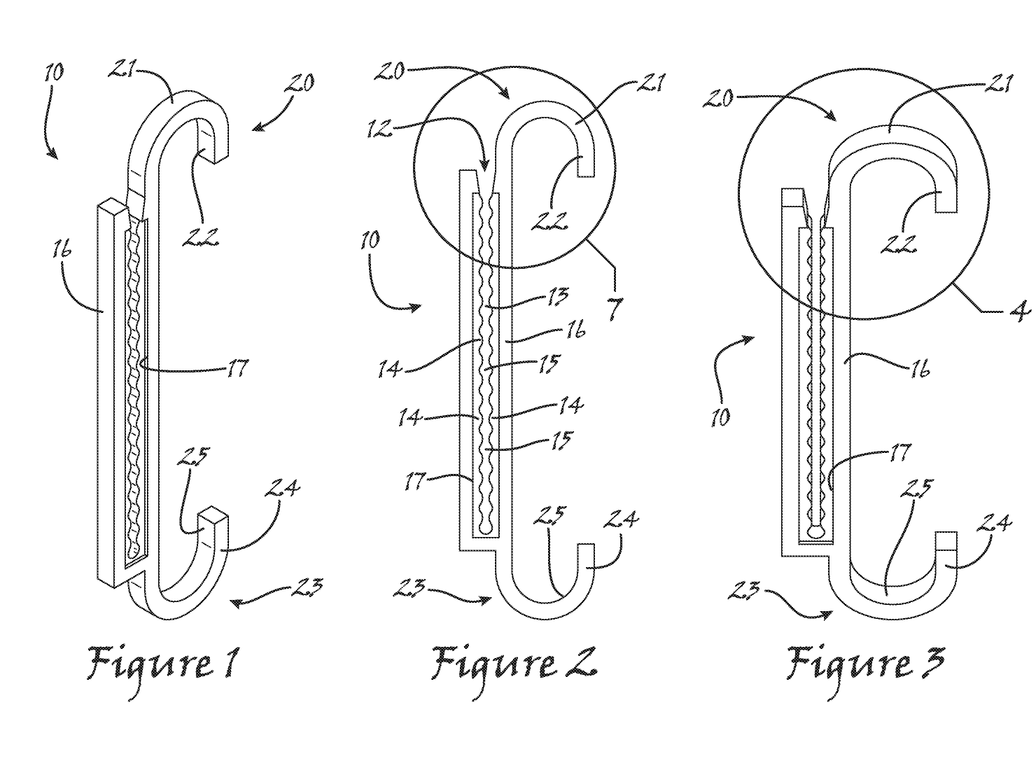

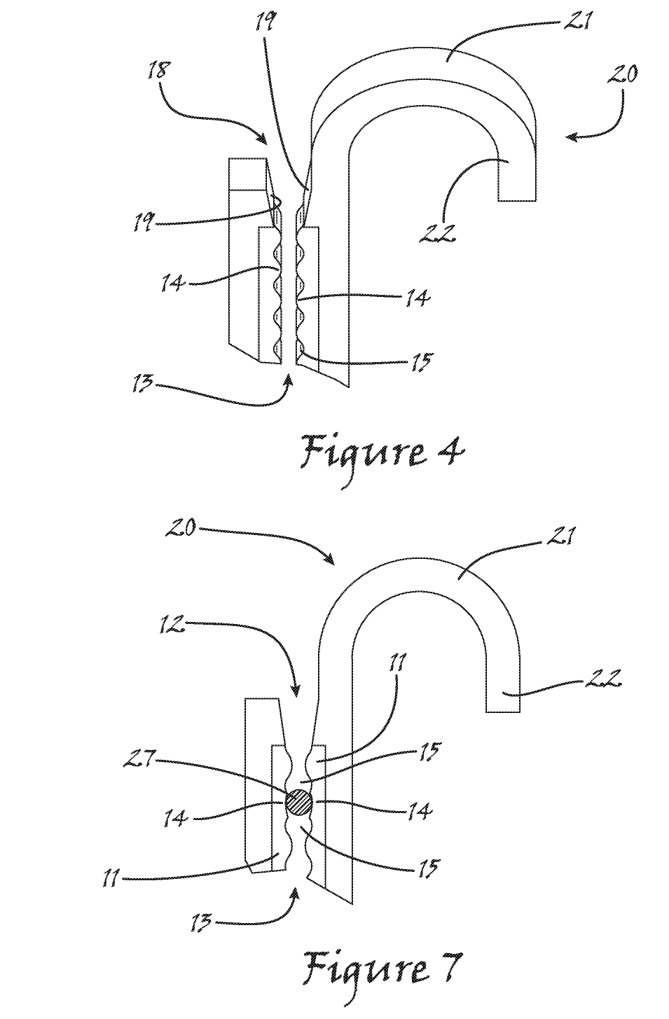

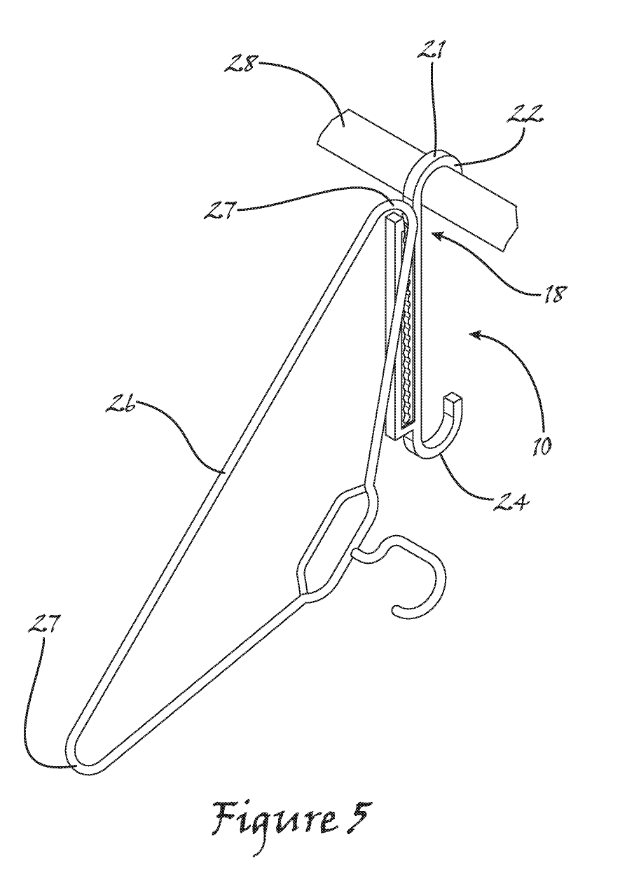

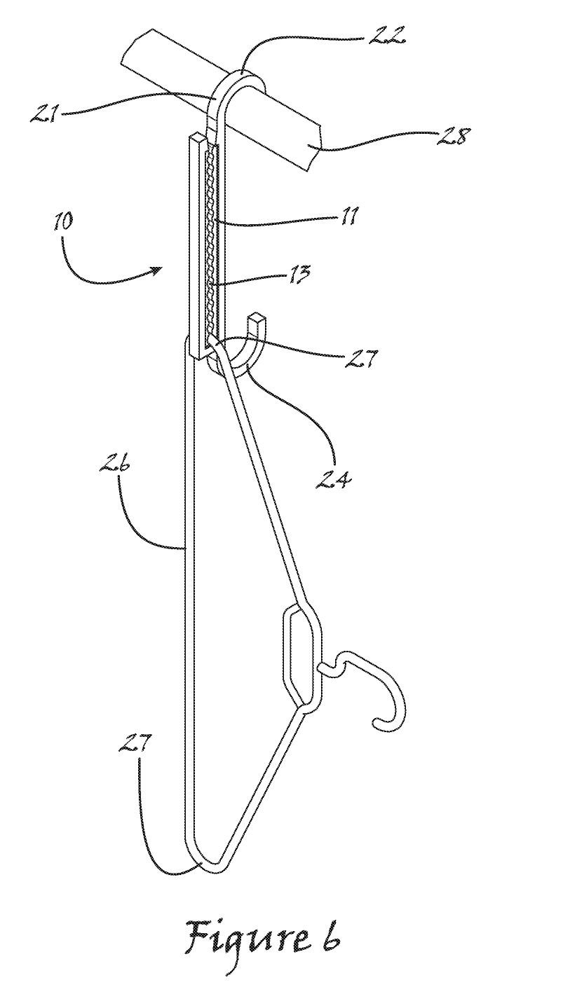

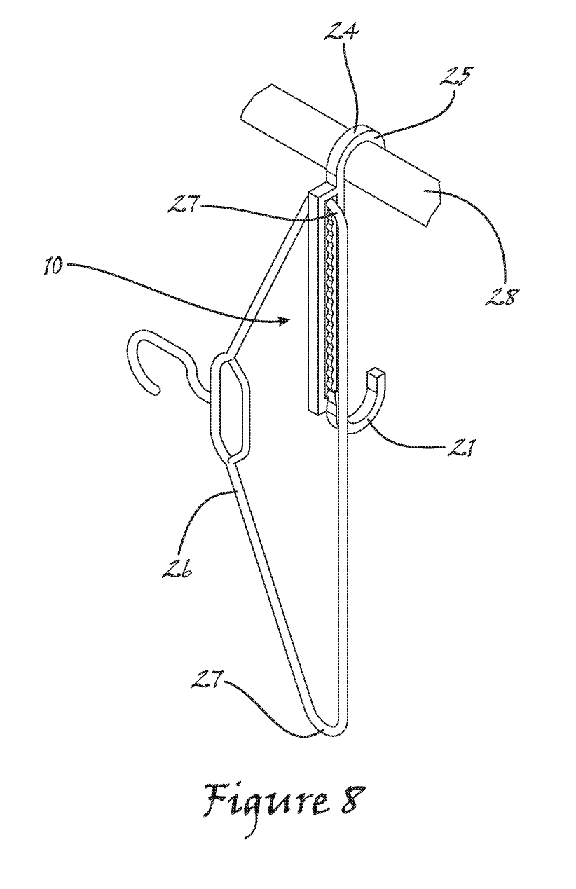

Referring now to the figures, and to FIGS. 1 through 3 in particular, the keeper 10 for orderly storage and/or conveyance of clothing hangers, as implemented in accordance with the preferred embodiment of the present invention, is shown to generally comprise a generally elongate hanger collection and retention chute 11 dependently supported within a chute support recess 17 provided in connection with a generally elongate rigid body 16. As shown in the figures, and as will also be better understood further herein, the chute 11 comprises an open end 12 to a central slot 13, running substantially the length of the chute 11, and whereby the chute 11 is adapted to receive therein the corner portion 27 of a number of clothing hangers 26. In order to facilitate collection of the hangers 26, the rigid body most preferably implements a guide 19 adapted to direct the corner portion 27 of a hanger 26 through an open throat 18 of the body 16 and into the open end 12 of the collection and retention chute 11, as particularly shown in FIG. 4.

In order to receive and keep organized a plurality of clothing hangers 26, the preferred implementation of the collection and retention chute 11 of the present invention provides a plurality of clothing hanger support slots 15. Protuberances 14, which are provided in generally aligned pairs extending from the interior side walls of the chute 11, jut inward toward the central slot 13 to demark, and serve as stops between, adjacent hanger support slots 15. In order to enable passage, as desired, of the corner region 27 of a hanger 26 while also serving to demark the hanger slots 15, the chute 11 is formed of a malleable material such that at least the protuberances 14 are adapted to give way to a passing corner region 27 of a hanger 26, as particularly depicted in FIG. 7. To this end, Applicant has found that the chute 11 may be constructed such materials as a polyurethane foam core encased in a polyethylene vinyl or like material covering, giving the chute the described desired ductility, malleability and low friction, as well as being generally wear resistant.

In use, as shown in FIG. 5, the keeper 10 of the present invention is initially hung from a closet type hanger rod 28, or the like, by a first fastener 21, such as, for example, the depicted hook 22, which first fastener 21 is provided at a first end 20 of the rigid body 16 adjacent to the open throat 18. The corner portion 27 of a hanger 26 is then directed into the chute 11, as shown in FIG. 5, and then pulled through the various hanger support slots 15 to arrive at a desired location, as depicted in FIG. 6. As previously mentioned, and as shown in FIG. 7, the various protuberances 14 will give way under the manual pulling force to enable the corner portion 27 of the hanger 26 to pass between adjacent hanger support slots 15. On the other hand, the protuberances will, in the absence of manual force, generally maintain a hanger 26 in place, as shown in FIG. 8.

Finally, FIG. 8 shows the keeper 10 as positioned for dispensing a previously collected clothing hanger 26. In particular, the keeper 10 is shown dependently supported from the closet type hanger rod 28 through a second fastener 24, which like the first fastener 21 may comprise a hook 28 or any substantial equivalent thereof. The second fastener 24 is provided at a second end 23 of the rigid body 16 generally opposite the open throat 18. In this manner, as will, in light of this exemplary description, be apparent to those of ordinary skill in the art, a hanger 26 may be readily dispensed from the keeper 10 by simply pulling the hanger 26 downward through the central slot 13 of the chute 11 and out the open end 12 of the chute 11.

While the foregoing description is exemplary of the preferred embodiment of the present invention, those of ordinary skill in the relevant arts will recognize the many variations, alterations, modifications, substitutions and the like as are readily possible, especially in light of this description, the accompanying drawings and claims drawn thereto. In any case, because the scope of the present invention is much broader than any particular embodiment, the foregoing detailed description should not be construed as a limitation of the scope of the present invention, which is limited only by the claims appended hereto.

1. A keeper for orderly storage and conveyance of clothing hangers, said keeper comprising:
a substantially rigid, elongate body, said rigid body having a first fastener at a first end of said body;
a hanger collection and retention chute, said hanger collection and retention chute being dependently supported along the length of said body; and
wherein said hanger collection and retention chute comprises:
a central slot running substantially the length of said chute;
an open end to said central slot, said open end being provided adjacent said first end of said body;
a plurality of hanger support slots positioned along said central slot;
a plurality of pair wise provided protuberances demarking adjacent ones of said hanger support slots, wherein at least one protuberance of each said pair of protuberances is malleable; and
wherein each said pair of protuberances is adapted to:
prevent, in the absence of manual force, passage of a portion of a hanger between a first one of said adjacent hanger support slots and a second one of said adjacent hanger support slots; and
enable, under manual force applied to said portion of a hanger, passage between said pair of protuberances from said first one of said adjacent hanger support slots to said second one of said adjacent hanger support slots.

2-5. (canceled)

6. A keeper for orderly storage and conveyance of clothing hangers, said keeper comprising:
a substantially rigid, elongate body, said rigid body having a first fastener at a first end of said body and a second faster at a second end of said body;
a hanger collection and retention chute, said hanger collection and retention chute being dependently supported along the length of said body; and
wherein said hanger collection and retention chute comprises:
a central slot running substantially the length of said chute;
an open end to said central slot, said open end being provided adjacent said first end of said body;
a plurality of hanger support slots positioned along said central slot;
a plurality of pair wise provided protuberances demarking adjacent ones of said hanger support slots; and
a substantially malleable material, and said substantially malleable material comprises a polyurethane foam core encased in a polyethylene vinyl covering.

7. (canceled)

8. A keeper for orderly storage and conveyance of clothing hangers, said keeper comprising:
a substantially rigid, elongate body, said rigid body having a first fastener at a first end of said body and a second faster at a second end of said body;
a hanger collection and retention chute, said hanger collection and retention chute being dependently supported along the length of said body;
wherein said hanger collection and retention chute comprises:
a central slot running substantially the length of said chute;
an open end to said central slot, said open end being provided adjacent said first end of said body;
a plurality of hanger support slots positioned along said central slot; and
a plurality of pair wise provided protuberances demarking adjacent ones of said hanger support slots; and
wherein:
said protuberances each comprise a substantially malleable material; and
said substantially malleable material comprises a polyurethane foam core encased in a polyethylene vinyl covering.

9. The keeper for orderly storage and conveyance of clothing hangers as recited in claim 1, wherein said rigid body has a second fastener at a second end of said body.

10. The keeper for orderly storage and conveyance of clothing hangers as recited in claim 9, wherein said second fastener comprises a hook.

11. The keeper for orderly storage and conveyance of clothing hangers as recited in claim 10, wherein said first fastener comprises a hook.

12. The keeper for orderly storage and conveyance of clothing hangers as recited in claim 1, wherein said first fastener comprises a hook.

13. The keeper for orderly storage and conveyance of clothing hangers as recited in claim 1, wherein each said malleable protuberance comprises a polyurethane foam core encased in a polyethylene vinyl covering.

14. The keeper for orderly storage and conveyance of clothing hangers as recited in claim 1, wherein each protuberance of each said pair of protuberances is malleable.

15. The keeper for orderly storage and conveyance of clothing hangers as recited in claim 14, wherein said rigid body has a second fastener at a second end of said body.

16. The keeper for orderly storage and conveyance of clothing hangers as recited in claim 15, wherein said second fastener comprises a hook.

17. The keeper for orderly storage and conveyance of clothing hangers as recited in claim 16, wherein said first fastener comprises a hook.

18. The keeper for orderly storage and conveyance of clothing hangers as recited in claim 14, wherein said first fastener comprises a hook.

19. The keeper for orderly storage and conveyance of clothing hangers as recited in claim 14, wherein each said malleable protuberance comprises a polyurethane foam core encased in a polyethylene vinyl covering.

20. The keeper for orderly storage and conveyance of clothing hangers as recited in claim 1, wherein said chute, including each protuberance of each said pair of protuberances, comprises a substantially malleable material.

21. The keeper for orderly storage and conveyance of clothing hangers as recited in claim 20, wherein said rigid body has a second fastener at a second end of said body.

22. The keeper for orderly storage and conveyance of clothing hangers as recited in claim 21, wherein said second fastener comprises a hook.

23. The keeper for orderly storage and conveyance of clothing hangers as recited in claim 22, wherein said first fastener comprises a hook.

24. The keeper for orderly storage and conveyance of clothing hangers as recited in claim 20, wherein said first fastener comprises a hook.

25. The keeper for orderly storage and conveyance of clothing hangers as recited in claim 20, wherein said substantially malleable material comprises a polyurethane foam core encased in a polyethylene vinyl covering.
